(19) United States
(12) Patent Application Publication
(10) Pub. No.: US 2026/0197570 A1
(43) Pub. Date: Jul. 9, 2026

(54) SPEAKER INCLUDING SUPPORT STRUCTURE AND ELECTRONIC DEVICE INCLUDING THE SAME

(71) Applicants: SAMSUNG ELECTRONICS CO., LTD., Suwon-si (KR); EM-TECH CO., LTD., Changwon-si (KR)

(72) Inventors: Joonrae CHO, Suwon-si (KR); Dongwoo SEOK, Changwon-si (KR); Gangtae KIM, Changwon-si (KR); Myeungseon KIM, Suwon-si (KR); Jihoon SONG, Suwon-si (KR); Heungwoo JEONG, Changwon-si (KR); Kiwon KIM, Suwon-si (KR); Woojin CHO, Suwon-si (KR); Jihoon KIM, Changwon-si (KR); Cheonmyeong KIM, Changwon-si (KR); Jungyeol AN, Suwon-si (KR)

(21) Appl. No.: 19/553,597

(22) Filed: Mar. 2, 2026

Related U.S. Application Data
(63) Continuation of application No. PCT/KR2024/012283, filed on Aug. 19, 2024.

(30) Foreign Application Priority Data
Sep. 26, 2023 (KR) 10-2023-0129888
Nov. 1, 2023 (KR) 10-2023-0149509

(51) Int. Cl. H04R 1/02; H04R 7/20; H04R 9/02; H04R 9/04; H04R 9/06

(52) U.S. Cl. CPC H04R 1/025; H04R 7/20; H04R 9/025; H04R 9/045; H04R 9/06; H04R 2400/11; H04R 2499/11

(57) ABSTRACT

An electronic device according to an embodiment may comprise: a housing comprising a fastening portion; and a speaker assembly which is arranged inside the housing and which outputs an audio signal. The speaker assembly may comprise a support structure that forms a magnetic field. The speaker assembly may comprise: a coil configured to vibrate due to the magnetic field; and a diaphragm attached to the coil. The support structure may be fastened to the fastening portion to couple the speaker assembly to the housing.

### CROSS-REFERENCE TO RELATED APPLICATIONS

This application is a continuation application of International Application No. PCT/KR 2024/012283 designating the United States and filed on Aug. 19, 2024, in the Korean Intellectual Property Receiving Office and claiming priority to Korean Patent Application No. 10-2023-0129888 filed on Sep. 26, 2023 and Korean Patent Application No. 10-2023-0149509 filed on Nov. 1, 2023 in the Ministry of Intellectual Property, the disclosures of which are incorporated by reference herein in their entireties.

### BACKGROUND

### (1) Field

The following embodiments relate to a speaker including a support structure, and an electronic device including the same.

### (2) Description of the Related Art

A small-sized electronic device, such as a smart phone, a tablet personal computer (PC), or a smart watch, may include a speaker for outputting audio signals. Such a speaker may be miniaturized so as to be mounted within the electronic device. The speaker may include a support structure for supporting the speaker in order to reduce functional degradation of the speaker (e.g., degradation in sound quality) caused by an external impact on the electronic device.

The above information is presented as background information only to assist with an understanding of the disclosure. No determination has been made, and no assertion is made, as to whether any of the above might be applicable as prior art with regard to the disclosure.

### SUMMARY

According to an embodiment, an electronic device may include a housing including a fastening portion. The electronic device may include a speaker assembly disposed within the housing and configured to output audio. The speaker assembly may include a support structure forming a magnetic field and including a first plate, a magnet attached to the first plate, and a second plate coupled with the first plate and disposed at least partially on the magnet. The speaker assembly may include a coil configured to vibrate by the magnetic field, and a diaphragm attached to the coil. The support structure may be fastened to the fastening portion for coupling the speaker assembly to the housing.

According to an embodiment, an electronic device may include a housing including a fastening portion. The electronic device may include a speaker assembly disposed within the housing and configured to output audio. The speaker assembly may include a support structure forming a magnetic field and including a first plate, a magnet attached to the first plate, a second plate coupled with the first plate and disposed at least partially on the magnet, and a fastening structure supported by the fastening portion and for fastening the speaker assembly to the fastening portion. The speaker assembly may include a diaphragm configured to vibrate by the magnetic field. The fastening structure may be formed at least partially by at least one of the first plate and the second plate.

### BRIEF DESCRIPTION OF THE DRAWINGS

FIG. 1 is a block diagram of an electronic device in a network environment according to various embodiments.

FIG. 2A is a front perspective view of an electronic device according to an embodiment.

FIG. 2B is a rear perspective view of an electronic device of FIG. 2A.

FIG. 3 is an exploded perspective view of an electronic device of FIG. 2A.

FIG. 4A is a partial perspective view of an electronic device, and FIG. 4B is an enlarged view of a portion of the electronic device of FIG. 4A.

FIG. 4C is a partial cross-sectional view of an electronic device taken along line A-A′ of FIG. 4A.

FIG. 5A is an exploded perspective view of a speaker assembly of an example electronic device.

FIG. 5B is a partially exploded perspective view of a speaker assembly of the example electronic device.

FIG. 5C is a perspective view of the speaker assembly of an example electronic device.

FIG. 6A is a partially exploded perspective view of a speaker assembly of an example electronic device.

FIG. 6B is a perspective view of a speaker assembly of an example electronic device.

FIGS. 7A, 7B, 7C, 7D, and 7E are perspective views of a speaker assembly of an example electronic device.

FIG. 8A illustrates a portion of an example electronic device.

FIG. 8B is a partial cross-sectional view of an example electronic device taken along line B-B′ of FIG. 8A.

### DETAILED DESCRIPTION

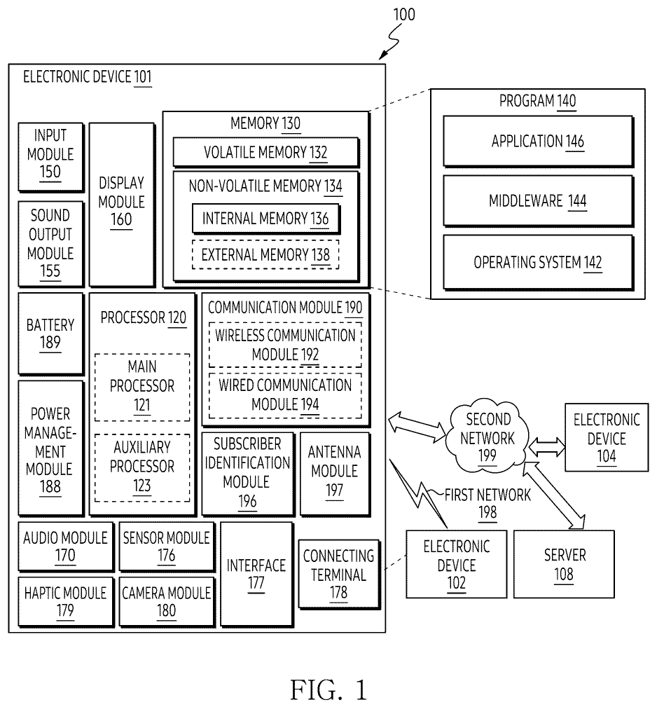

FIG. 1 is a block diagram of an electronic device in a network environment according to an embodiment.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In an embodiment, at least one of the components (e.g., the connecting terminal 178) may be omitted from the electronic device 101, or one or more other components may be added in the electronic device 101. In an embodiment, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) which is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may, for example, control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., the electronic device 102)(e.g., speaker or headphone) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors which are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

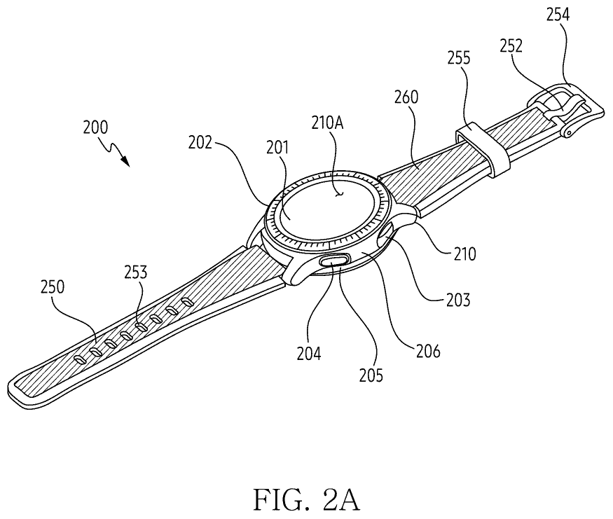

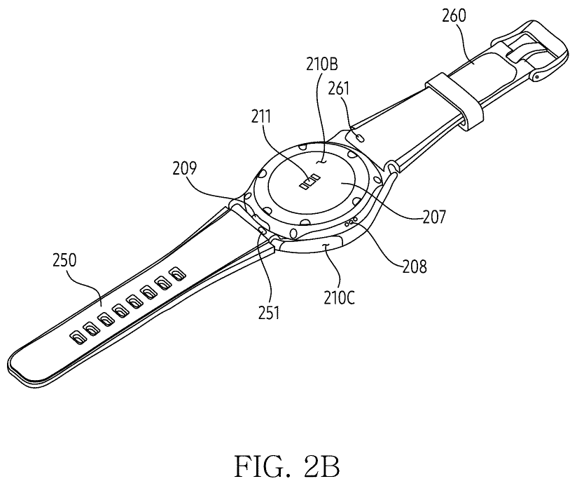

FIG. 2A is a front perspective view of an electronic device 200 according to an embodiment. FIG. 2B is a rear perspective view of the electronic device 200 of FIG. 2A.

Referring to FIGS. 2A and 2B, an electronic device 200 according to an embodiment may include a housing 210 including a front surface 210A, a rear surface 210B, and a side surface 210C surrounding a space which is between the front surface 210A and the rear surface 210B, and fastening members 250 and 260 connected to at least a portion of the housing 210 and configured to detachably fasten the electronic device 200 to a body part such as part of a user's body (e.g., a wrist or an ankle). In an embodiment (not shown), the housing may refer to a structure forming (or providing) some of the front surface 210A, the rear surface 210B, and the side surfaces 210C of FIG. 1.

According to an embodiment, at least a portion of the front surface 210A may be formed with a front plate 201 (e.g., a glass plate or a polymer plate including various coating layers) which is substantially transparent. The rear surface 210B may be formed with a rear plate 207 which is substantially opaque. The rear plate 207 may be formed of (or made of), for example, coated or colored glass, ceramic, polymer, metal (e.g., aluminum, stainless steel (STS), or magnesium), or a combination of at least two of the above materials. The side surface 210C may be coupled with the front plate 201 and the rear plate 207, and may be formed with a side bezel structure 206 including a metal and/or a polymer material. In an embodiment, the rear plate 207 and the side bezel structure 206 may be integrally formed and include the same material (e.g., a metallic material such as aluminum). The fastening members 250 and 260 may be formed of various materials and shapes. The fastening members may be formed of fabrics, leather, rubber, urethane, metal, ceramic, or a combination of at least two of the above materials, such that an integrated type or a plurality of unit links are movable relative to each other.

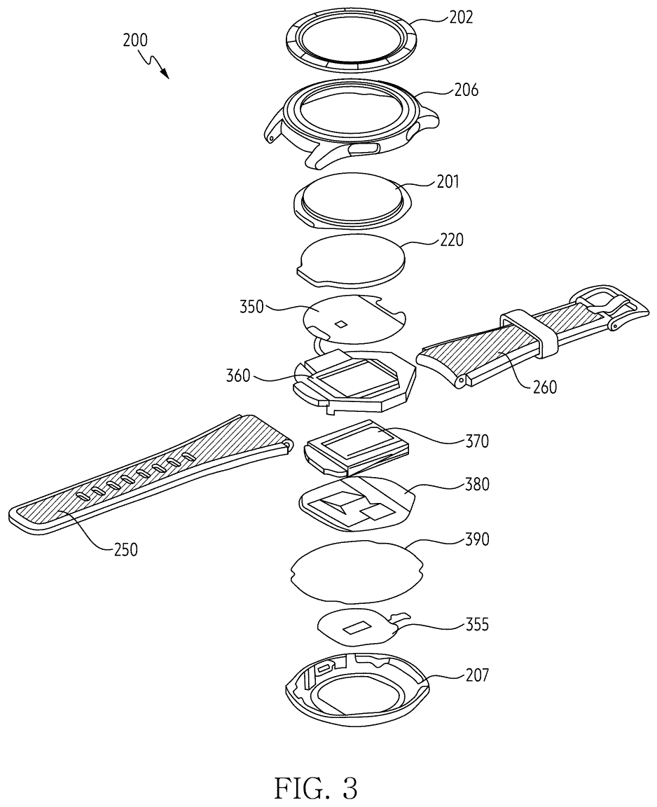

According to an embodiment, the electronic device 200 may include at least one of a display 220 (refer to FIG. 3), audio modules 205 and 208, a sensor module 211, key input devices 202, 203, and 204, and a connector hole 209. In an embodiment, the electronic device 200 may omit at least one of those components (e.g., the key input devices 202, 203, and 204, the connector hole 209, or the sensor module 211) or may further include any other components.

The display 220 may be, for example, visually exposed through a substantial portion of the front plate 201. The shape (e.g., a planar shape) of the display 220 may correspond to the shape of the front plate 201, and may be formed in various shapes including a circle, an ellipse, or a polygon. The display 220 may be coupled with or disposed adjacent to a touch sensing circuit, a pressure sensor capable of measuring an intensity (pressure) of a touch, and/or a fingerprint sensor.

The audio modules 205 and 208 may include a microphone hole 205 and a speaker hole 208. A microphone as a sound input (or audio signal input) for obtaining external sound may be disposed inside the microphone hole 205, and in some embodiments, a plurality of microphones may be disposed to sense the direction of the sound. The speaker hole 208 as a sound input (or audio signal output) may be used as an external speaker and a receiver for calls. In some embodiments, the speaker hole 208 and the microphone hole 205 may be implemented as a single hole, or a speaker (e.g., a piezo speaker) without the speaker hole 208 may be included.

The sensor module 211 may generate an electrical signal or a data value corresponding to an internal operating state of the electronic device 200 or an external environmental state. The sensor module 211 may include, for example, a biometric sensor module 211 (e.g., a heart rate monitor (HRM) sensor) disposed on the rear surface 210B of the housing 210. The electronic device 200 may further include at least one of sensor modules (not shown), for example, gesture sensor, gyro sensor, barometric pressure sensor, magnetic sensor, acceleration sensor, grip sensor, color sensor, IR (infrared) sensor, biometric sensor, temperature sensor, humidity sensor, illuminance sensor or the like.

The key input devices 202, 203, and 204 may include a wheel key 202 disposed on the front surface 210A of the housing 210 and being rotatable in at least one direction, and/or key buttons 203 and 204 disposed on the side surface 210C of the housing 210. The wheel key may have a shape corresponding to the shape of the front plate 201. In an embodiment, the electronic device 200 may not include some or all of the above-mentioned key input devices 202, 203, and 204, and the key input devices 202, 203, and 204 not included may be implemented in other forms such as soft keys on the display 220.

The connector hole 209 may accommodate a connector (e.g., a universal serial bus (USB) connector) for transmitting and receiving power and/or data with an external electronic device, and may include another connector hole (not shown) capable of accommodating a connector for transmitting and receiving audio signals with an external electronic device. The electronic device 200 may further include, for example, a connector cover (not shown) which covers at least a portion of the connector hole 209 and blocks an inflow of external foreign substances into the connector hole.

The fastening members 250 and 260 may be detachably fastened to at least partial regions of the housing 210, such as by using locking members 251 and 261. The fastening members 250 and 260 may include one or more of a fixing member 252, a fixing member fastening hole 253, a band guide member 254, and a band fixing ring 255.

The fixing member 252 may be configured to fix the housing 210 and the fastening members 250 and 260 to a part of the user's body (e.g., a wrist or an ankle). Engagement of the fixing member fastening hole 253 with the fixing member 252 may fix the housing 210 and the fastening members 250 and 260 to a part of the user's body. The band guide member 254 may be configured to limit the range of motion of the fixing member 252 when the fixing member 252 is fastened to the fixing member fastening hole 253, thereby allowing the fastening members 250 and 260 to be fastened in close contact with a part of the user's body. The band fixing ring 255 may limit the range of motion of the fastening members 250 and 260 while the fixing member 252 and the fixing member fastening hole 253 are fastened.

FIG. 3 is an exploded perspective view of an electronic device 200 of FIG. 2A.

Referring to FIG. 3, the electronic device 200 may include a side bezel structure 206, a wheel key 202, a front plate 201, a display 220, a first antenna 350, a second antenna 355, a support member 360 (e.g., a bracket), a battery 370, a printed circuit board 380, a sealing member 390, a rear plate 207, and/or fastening members 250 and 260. At least one of the components of the electronic device 200 may be the same as or similar to at least one of the components of the electronic device 101 of FIG. 1 or the electronic device 200 of FIG. 2A, and any redundant descriptions will not be reiterated below. The support member 360 may be disposed inside the electronic device 200 and connected to the side bezel structure 206, or may be integrally formed with the side bezel structure 206. The support member 360 may be formed of, for example, a metallic material and/or a non-metallic material (e.g., a polymer). The support member 360 may be configured such that the display 220 is coupled to one surface thereof and the printed circuit board 380 is coupled to the other surface thereof. A processor, a memory, and/or an interface may be mounted on the printed circuit board 380. The processor may include, for example, one or more of a central processing unit, an application processor, a graphic processing unit (GPU), an application processor, a sensor processor, or a communication processor.

The memory may include, for example, a volatile memory or a non-volatile memory. The interface may include, for example, a high-definition multimedia interface (HDMI), a universal serial bus (USB) interface, an SD card interface, and/or an audio interface. The interface may, for example, electrically or physically connect the electronic device 200 to an external electronic device, and may include a USB connector, an SD card/MMC connector, or an audio connector.

The battery 370, which is a device for supplying power (e.g., electrical power) to at least one component of the electronic device 200, may include, for example, a non-rechargeable primary cell, a rechargeable secondary cell, or a fuel cell. At least a portion of the battery 370 may be disposed, for example, on substantially the same plane as the printed circuit board 380 (e.g., coplanar). For example, the vertical direction in FIG. 3 may represent a thickness direction (such as a third direction) of the electronic device 200 and various components or layers thereof. Each of the elements shown in FIG. 3 may be disposed in a plane defined by a first direction (such as along the length of the fastening members 250 and 260) and a second direction crossing the first direction (such as being perpendicular to the first direction, without being limited thereto) The battery 370 may be integrally disposed inside the electronic device 200 to be fixed therein, or may be disposed to be attached to/detachable from the electronic device 200.

The first antenna 350 may be disposed between the display 220 and the support member 360. The first antenna 350 may include, for example, a near field communication (NFC) antenna, a wireless charging antenna, and/or a magnetic secure transmission (MST) antenna. The first antenna 350 may, for example, perform short-range communication with an external device, wirelessly transmit and receive power required for charging, and transmit a magnetic-based signal including a short-range communication signal or payment data. In an embodiment, an antenna structure may be formed of a part of the side bezel structure 206 and/or the support member 360 or a combination thereof.

The second antenna 355 may be disposed between the circuit board 380 and the rear plate 207. The second antenna 355 may include, for example, a near field communication (NFC) antenna, a wireless charging antenna, and/or a magnetic secure transmission (MST) antenna. The second antenna 355 may, for example, perform short-range communication with an external device, wirelessly transmit and receive power required for charging, and transmit a magnetic-based signal including a short-range communication signal or payment data. In an embodiment, an antenna structure may be formed of a part of the side bezel structure 206 and/or the rear plate 207 or a combination thereof.

The sealing member 390 may be located between the side bezel structure 206 and the rear plate 207. The sealing member 390 may be configured to prevent moisture and foreign substances from being introduced into a space surrounded by the side bezel structure 206 and the rear plate 207 from the outside.

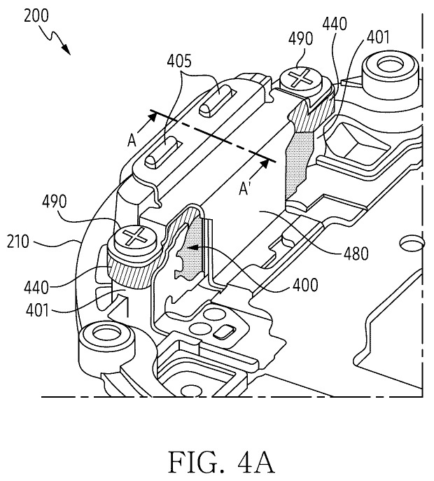

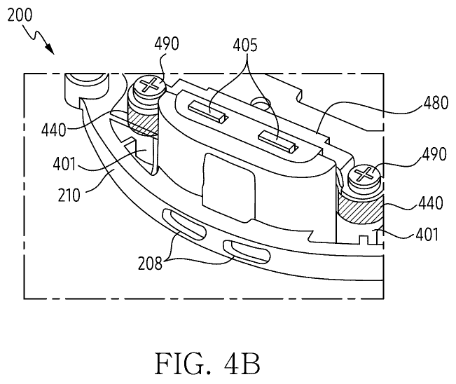

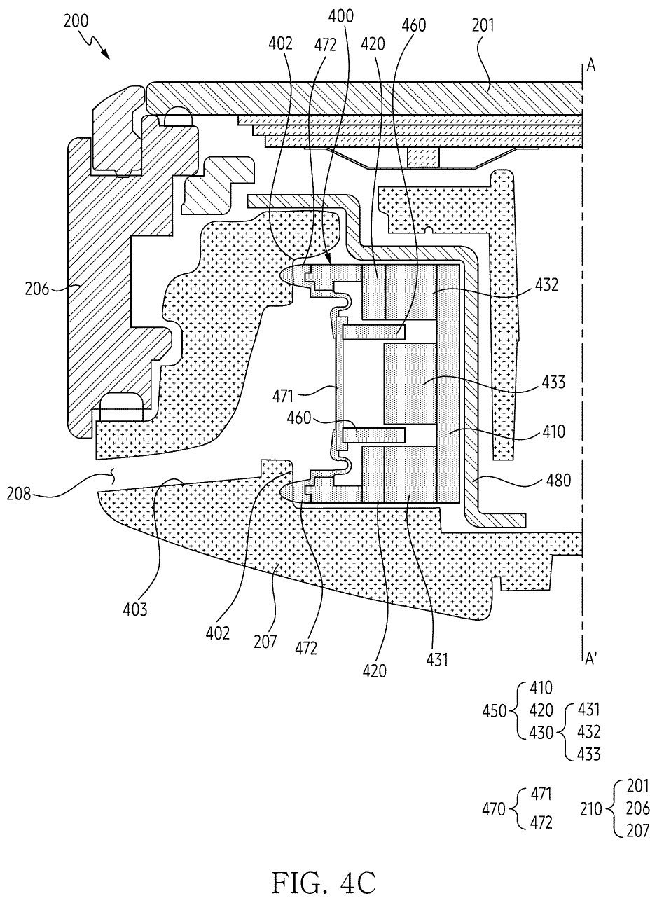

FIG. 4A is a partial perspective view of an end region of an electronic device 200. FIG. 4B is an enlarged portion of the end of the electronic device 200. FIG. 4C is a partial cross-sectional view of the example electronic device taken along line A-A′ of FIG. 4A. The end region S may of the electronic device 200 may include an audio module, like the speaker hole 208.

Referring to FIGS. 4A, 4B and 4C, the electronic device 200 may include a housing 210 and a speaker assembly 400. The speaker assembly 400 may include a support structure 450, a coil 460, and a diaphragm 470.

According to an embodiment, the electronic device 200 may be referred to as a wearable device which may be worn on a part of a user's body (e.g., a wrist). For example, a front surface (e.g., the front surface 210A of FIG. 2A) of the housing 210 of the electronic device 200 may provide visual information to a user through a display (e.g., the display 220 of FIG. 3) of the electronic device 200. A rear surface 210B opposite to the front surface 210A of the housing 210 may face a part of the user's body while the electronic device 200 is worn by the user. The electronic device 200 may detect the user's biometric information through a sensor module (e.g., the sensor module 211 of FIG. 2B) disposed on the rear surface 210B. For example, the electronic device 200 may be connected to an external electronic device (e.g., the electronic device 101 of FIG. 1). The electronic device 200 may provide information related to the user via the external electronic device 101. The electronic device 200 may be referred to as the electronic device 102 or the electronic device 104 of FIG. 1 in that it may be connected to the external electronic device 101, but the disclosure is not limited thereto.

According to an embodiment, the housing 210 may include a front plate 201, a rear plate 207, and/or a side bezel structure 206. For example, the front plate 201 may be disposed on a display (e.g., the display 220 of FIG. 3) for providing visual information to a user. For example, the rear plate 207 may face a part of the user's body (e.g., a wrist) while the electronic device 200 is worn by the user. The rear plate 207 may include, for example, a speaker hole 208 for sound output from the speaker assembly 400. For example, the side bezel structure 206 may surround a space between the front plate 201 and the rear plate 207. The side bezel structure 206 may, for example, wrap at least a portion of the front plate 201 and/or at least a portion of the rear plate 207.

According to an embodiment, the housing 210 may include a fastening portion 401. The fastening portion 401 may be a portion for fastening the speaker assembly 400 to the housing 210. For example, the fastening portion 401 may be fastened with the speaker assembly 400 to fix the speaker assembly 400 inside the housing 210. For example, the fastening portion 401 may be coupled with the speaker assembly 400 to fix the position of the speaker assembly 400 relative to the housing 210. For example, the fastening portion 401 to which the speaker assembly 400 is fastened may be formed on the rear plate 207 of the housing 210 of FIG. 2B, but the disclosure is not limited thereto.

According to an embodiment, the speaker assembly 400 may be disposed within the housing 210. The speaker assembly 400 may be configured to output audio. For example, the speaker assembly 400 may be fastened to the fastening portion 401 of the housing 210. For example, the speaker assembly 400 may be disposed between the front surface 210A of the housing 210 and the rear surface 210B opposite to the front surface 210A. For example, the speaker assembly 400 may be coupled to the rear plate 207 of the housing 210, but the disclosure is not limited thereto. For example, the speaker assembly 400 may be disposed within the housing 210 to face the speaker hole 208 of the housing 210, in order to transmit audio output from the speaker assembly 400 to the outside of the electronic device 200, through the speaker hole 208. The speaker assembly 400 may be configured to output the audio to the outside of the housing 210 to provide sound to the user.

According to an embodiment, the support structure 450 may form a magnetic field. The support structure 450 may include a first plate 410, a second plate 420, and a magnet 430. For example, the support structure 450 may be configured to vibrate the diaphragm 470 of the speaker assembly 400 by forming a magnetic field. The support structure 450 may provide a space for a coil 460 attached to the diaphragm 470 in order to vibrate the diaphragm 470. As the diaphragm 470 is vibrated by the magnetic field formed within the support structure 450, audio may be output from the speaker assembly 400. For example, the support structure 450 may be supported by at least a portion of the housing 210 (e.g., the fastening portion 401). For example, the support structure 450 may form at least a portion of an appearance of the speaker assembly 400.

According to an embodiment, the first plate 410 may support at least some of the components included in the speaker assembly 400. For example, the first plate 410 may form a magnetic circuit within the speaker assembly 400 together with the magnet 430. For example, the first plate 410 may face the inside of the housing 210 while the speaker assembly 400 is fastened to the housing 210. The first plate 410 may be referred to as a yoke of the speaker assembly 400, but the disclosure is not limited thereto.

According to an embodiment, the second plate 420 may be coupled with the first plate 410. The second plate 420 may be disposed at least partially on the magnet 430. For example, the second plate 420 may be supported by the magnet 430. By being attached to the magnet 430, the second plate 420 may be configured such that magnetic flux of a magnetic field formed by the magnet 430 is concentrated in the support structure 450. The second plate 420 may be referred to as a top plate of the speaker assembly 400, but the disclosure is not limited thereto.

According to an embodiment, the magnet 430 may be attached to the first plate 410. The magnet 430 may be disposed at least partially between the first plate 410 and the second plate 420. For example, the magnet 430 may be coupled with the first plate 410 and the second plate 420. The magnet 430 may be at least partially interposed between the first plate 410 and the second plate 420. The magnet 430 may form a magnetic field together with the first plate 410 and the second plate 420.

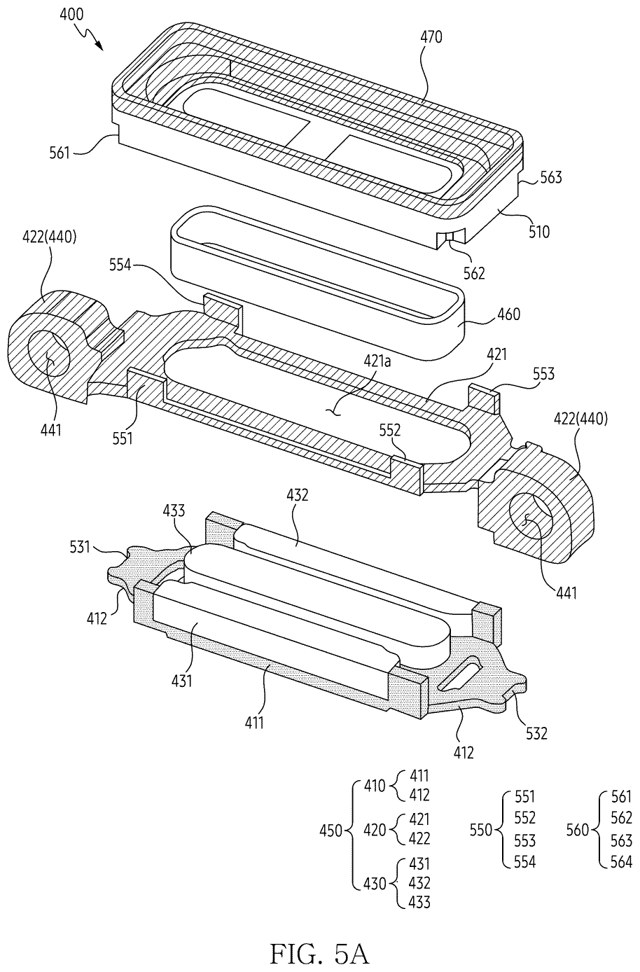

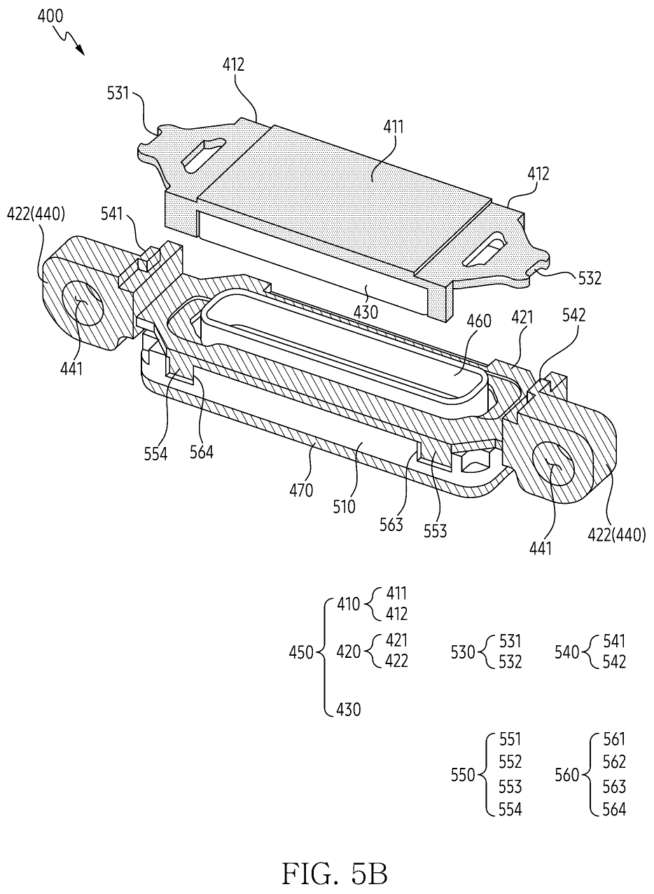

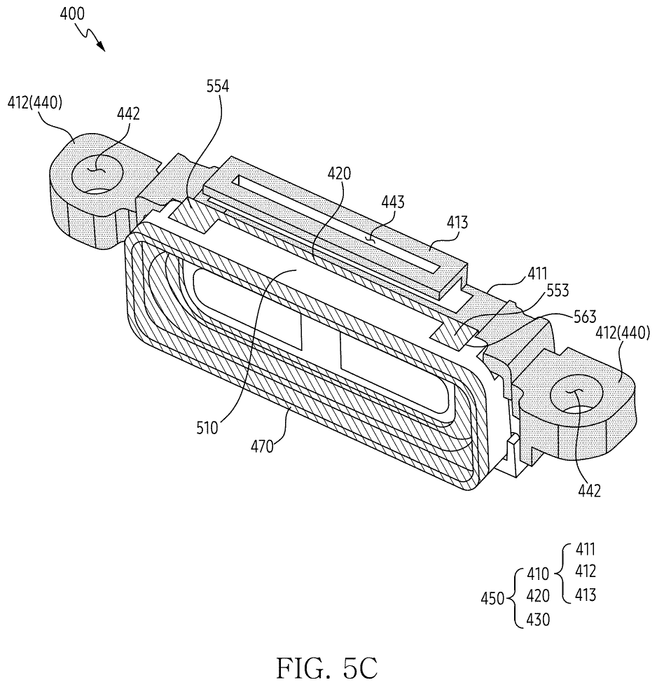

For example, the second plate 420 may be partially in contact with the first plate 410. For example, the second plate 420 may be coupled with the first plate 410. For example, since the second plate 420 and the first plate 410 are coupled, at least a portion of the first plate 410 and/or the second plate 420 may at least partially surround the magnet 430. As the support structure 450 is configured such that the first plate 410 and the second plate 420 are fastened, the coupling of the first plate 410 and the second plate 420 may prevent the magnet 430 from coming into contact with the coil 460 due to external impacts. Further, owing to the configuration of the first plate 410 and the second plate 420 being coupled, the support structure 450 may improve the sound quality of audio output from the speaker assembly 400. A structure for coupling the first plate 410 and the second plate 420 will be described below with reference to FIG. 5A and its subsequent drawings.

For example, the magnet 430 may include a first magnet 431, a second magnet 432 spaced apart from the first magnet 431, and/or a third magnet 433 between the first magnet 431 and the second magnet 432. For example, the support structure 450 may form a magnetic field by the first plate 410, the first magnet 431, the second plate 420, and the third magnet 433. For example, the support structure 450 may form a magnetic field by the first plate 410, the second magnet 432, the second plate 420, and the third magnet 433. Formation of the magnetic field in the support structure 450 may cause the coil 460 to vibrate by the magnetic field.

According to an embodiment, the coil 460 may be configured to vibrate by a magnetic field formed by the support structure 450. For example, the coil 460 may pass through the second plate 420. The coil 460 may be at least partially surrounded by the magnet 430. For example, the coil 460 may be at least partially disposed within the support structure 450. For example, the magnet 430 may include a first magnet 431, a second magnet 432, and a third magnet 433. The coil 460 may be configured to form sound waves through the diaphragm 470 by interacting with the magnet 430 through a current in the coil 460. For example, the coil 460 may include a conductive material. While an alternating current (AC) flows through the coil 460, the coil 460 may vibrate by the magnetic field formed within the support structure 450.

According to an embodiment, the diaphragm 470 may be attached to the coil 460. For example, the diaphragm 470 may be configured to vibrate based on the vibration of the coil 460 by the magnetic field formed in the support structure 450. For example, as the diaphragm 470 is vibrated by the coil 460, the pressure of air around the diaphragm 470 may be changed. The diaphragm 470 may be configured to output audio by changing the pressure of the air.

According to an embodiment, the housing 210 may include a speaker hole 208 and an acoustic duct 403 for audio output from the speaker assembly 400, the acoustic duct 403 extending from the speaker hole 208 to the diaphragm 470 of the speaker assembly 400 fastened to the fastening portion 401. For example, the speaker hole 208 may be formed at a side surface (e.g., the side surface 210C of FIG. 2A) of the housing 210. For example, the speaker hole 208 may be disposed adjacent to the fastening portion 401 to which the speaker assembly 400 is fastened, in order to transmit audio output from the speaker assembly 400 to the outside of the electronic device 200. For example, the acoustic duct 403 may be a path through which audio output from the speaker assembly 400 is transferred from an inside of the electronic device 200 to the outside of the electronic device 200. For example, the acoustic duct 403 may be connected from the speaker hole 208 to an internal space of the housing 210. For example, one end of the acoustic duct 403 may be connected to the speaker hole 208, to form an output of the acoustic duct 403. The other end opposite to the one end of the acoustic duct 403 may be connected to the diaphragm 470 of the speaker assembly 400 fastened to the fastening portion 401, to form an input of the acoustic duct 403. The housing 210 may include the speaker hole 208 and the acoustic duct 403 to provide a path for audio output from the speaker assembly 400. The speaker hole 208 may penetrate through a body of the rear plate 207, to acoustically connect the internal space of the housing 210 to the outside of the electronic device 200.

According to an embodiment, the housing 210 may include a support portion 402 for supporting the speaker assembly 400. The diaphragm 470 may include a first elastic member 471 attached to the coil 460, and a second elastic member 472 extending from the first elastic member 471 and configured to be at least partially pressed by the support portion 402 to reduce inflow of foreign substances from the outside of the electronic device 200 to the magnet 430. For example, the first elastic member 471 may be a portion of the diaphragm 470 which is deformable by the vibration of the coil 460. The first elastic member 471 may be a portion which outputs audio by the vibration of the coil 460. For example, the support portion 402 of the housing 210 may be a portion which contacts the diaphragm 470 of the speaker assembly 400 fastened to the fastening portion 401. The support portion 402 may be a portion where the acoustic duct 403 for the audio output from the speaker assembly 400 is formed.

For example, the second elastic member 472 may be coupled with the first elastic member 471 to support the first elastic member 471. The second elastic member 472 may be at least partially in contact with the support portion 402 of the housing 210. For example, by pressing the support portion 402, the second elastic member 472 may reduce foreign substances introduced from the outside of the electronic device 200 into the internal space of the housing 210, through the speaker hole 208 and the acoustic duct 403. As pressing the support portion 402, the second elastic member 472 may be held in position or taut by connection with the housing at the support portion 402, such as to withstand pressure from an inflow of foreign substances introduced from the outside of the electronic device 200. The second elastic member 472 may improve the sound quality of the speaker assembly 400 by reducing the inflow of foreign substances from the outside into the support structure 450 where the magnetic field of the speaker assembly 400 is formed. The second elastic member 472 may be referred to as a waterproof structure in that it reduces the inflow of foreign substances from the outside of the electronic device 200 into the electronic device 200, but the disclosure is not limited thereto.

According to an embodiment, the electronic device 200 may include a support member 480 which supports the first plate 410 of the speaker assembly 400 and is fastened to the fastening portion 401. For example, the support member 480 may cover at least a portion of the speaker assembly 400 fastened to the fastening portion 401. For example, the support member 480 may be fastened to the fastening portion 401 together with the speaker assembly 400. For example, a portion of the support member 480 may contact the speaker assembly 400. For example, a portion of the support member 480 may face the first plate 410 of the speaker assembly 400. Referring to FIG. 4C, a vertical portion extended along a thickness direction of the electronic device 200 may face the first plate 410 in a lateral (or planar) direction horizontally extended in the view. For example, the housing 210 may include a protruding structure 405 spaced apart from the fastening portion 401. The support member 480 may be coupled with the protruding structure 405 to support the speaker assembly 400, at a horizontal portion of the support member 480. The support member 480 may have variously extending portions which form a stepped structure of the support member 480. By including the support member 480, the electronic device 200 may reduce separation of the speaker assembly 400 from the housing 210 due to an external impact.

According to an embodiment, the speaker assembly 400 may include a fastening structure 440 fastened with the fastening portion 401 of the housing 210. For example, the fastening structure 440 may protrude from the speaker assembly 400. For example, the fastening structure 440 may extend from one component of the speaker assembly 400. For example, the fastening structure 440 may be supported by the fastening portion 401. By including the fastening structure 440 fastened to the fastening portion 401 of the housing 210, the speaker assembly 400 may reduce separation of the speaker assembly 400 from the housing 210.

According to an embodiment, the speaker assembly 400 may be pressed by foreign substances introduced from the outside of the electronic device 200. For example, the diaphragm 470 of the speaker assembly 400 may be pressed toward the internal space of the housing 210 by foreign substances introduced through the speaker hole 208 and through the acoustic duct 403 from the outside of the electronic device 200. The fastening structure 440 of the speaker assembly 400 may be formed along with the speaker assembly 400 due to the pressure exerted by the foreign substances. A structure may be used for the fastening structure 440 to reduce degradation of the sound quality of the speaker assembly 400 and to reduce inflow of the foreign substances into the internal space of the housing 210, as the fastening structure 440 is deformed. Such a structure of the fastening structure 440 for improving the fastening of the speaker assembly 400 to the housing 210 will be described below with reference to FIG. 5A and its subsequent drawings.

According to an embodiment, the electronic device 200 may include a fastening member 490 for fastening the speaker assembly 400 to the housing 210. For example, the fastening member 490 may fasten the fastening structure 440 of the speaker assembly 400 to the fastening portion 401. For example, the fastening member 490 may be coupled with at least a portion of the fastening structure 440 and the fastening portion 401. The fastening member 490 may pass through at least a portion of the fastening structure 440 and the fastening portion 401. For example, the electronic device 200 may include a support member 480 fastened to the fastening portion 401 and configured to support the speaker assembly 400. The fastening member 490 may be coupled with the fastening portion 401, the fastening structure 440 of the speaker assembly 400, and the support member 480, thereby fastening the speaker assembly 400 and the support member 480 to the fastening portion 401.

According to the above-described embodiment, the electronic device 200 may include the speaker assembly 400 to provide sound to a user of the electronic device 200. The speaker assembly 400 may include the support structure 450 and the diaphragm 470 configured to vibrate by the support structure 450 to output audio. The first plate 410 of the support structure 450 may improve the sound quality of audio output from the speaker assembly 400 by being coupled with the second plate 420.

FIG. 5A is an exploded perspective view of a speaker assembly 400 of an electronic device. FIG. 5B is a partially exploded perspective view of the speaker assembly of the example electronic device. FIG. 5C is a perspective view of the speaker assembly of the example electronic device.

Referring to FIGS. 5A, 5B, and 5C, the electronic device (e.g., the electronic device 200 of FIG. 2A) may include a housing (e.g., the housing 210 of FIG. 2A) including a fastening portion (e.g., the fastening portion 401 of FIG. 4A), and a speaker assembly 400 disposed within the housing 210 and configured to output audio. The speaker assembly 400 may include a support structure 450 forming a magnetic field and including a first plate 410, a magnet 430 attached to the first plate 410, and a second plate 420 coupled with the first plate 410 and disposed at least partially on the magnet 430. The speaker assembly 400 may include a coil 460 configured to vibrate by the magnetic field, and a diaphragm 470 attached to the coil 460.

Hereinafter, redundant descriptions of the components having the same reference numerals as those previously described in FIGS. 4A and 4B will not be reiterated.

According to an embodiment, the support structure 450 may be fastened to the fastening portion 401 of the housing 210 in order to couple the speaker assembly 400 to the housing 210. For example, the support structure 450 may be coupled with the housing 210. For example, at least a portion of the support structure 450 may be fastened with the fastening portion 401 to fix the position of the speaker assembly 400 with respect to the housing 210. For example, The support structure 450 may be fastened to the fastening portion 401 of the housing 210 at a portion of the first plate 410 and/or the second plate 420 of the support structure 450. The support structure 450 may be configured to be fastened to the fastening portion 401 of the housing 210, thereby improving the fastening integrity of the speaker assembly 400 with respect to the housing 210.

According to an embodiment, the support structure 450 may further include a fastening structure 440 supported by the fastening portion 401 and configured to fasten the speaker assembly 400 to the fastening portion 401. The fastening structure 440 may be formed at least partially by at least one of the first plate 410 and the second plate 420. For example, referring to FIGS. 5A and 5B, the fastening structure 440 may be formed on the second plate 420 of the support structure 450. With reference to FIG. 4C, the first plate 410, the second plate 420 and the diaphragm 470 are generally (horizontally) arranged along a planar direction, that is, the first direction, the second direction or another direction in a first-section direction plane. Since the second plate 420 is coupled with the first plate 410 on which the magnet 430 is attached, the fastening structure 440 may be coupled with the first plate 410 and the magnet 430.

The fastening structure 440 may be formed on the second plate 420, thereby improving the fastening integrity of the speaker assembly 400 to the housing 210 while the fastening structure 440 is fastened to the fastening portion 401 of the housing 210. For example, referring to FIG. 5C, as opposed to those shown in FIGS. 5A and 5B, the fastening structure 440 may be formed on the first plate 410 of the support structure 450. Since the first plate 410 on which the magnet 430 is attached is coupled with the second plate 420, the fastening structure 440 may be coupled with the second plate 420. The fastening structure 440 may be formed on the first plate 410, thereby improving the fastening integrity of the speaker assembly 400 to the housing 210 while the fastening structure 440 is fastened to the fastening portion 401 of the housing 210.

Although it has been described that the first plate 410 or the second plate 420 includes (or defines) the fastening structure 440, the disclosure is not limited thereto. Although not shown, the fastening structure 440 may be formed by a coupling of a portion of the first plate 410 and a portion of the second plate 420. As the fastening structure 440 is formed within the support structure 450 such that the support structure 450 is fastened to the housing 210, the fastening structure 440 may simplify the structure of the speaker assembly 400 and improve the fastening integrity of the speaker assembly 400 to the housing 210 while the speaker assembly 400 is fastened to the housing 210.

According to an embodiment, the first plate 410 and the second plate 420 may include metal. For example, the first plate 410 and the second plate 420 may each include metal, thereby forming a magnetic field within the support structure 450 together with the magnet 430. As the first plate 410 and the second plate 420 each include metal, the support structure 450 fastened to the fastening portion 401 of the housing 210 may improve the fastening integrity of the speaker assembly 400 to the housing 210.

Referring to FIGS. 5A and 5B, the second plate 420 may include a first portion 421 including a hole 421a defined therein for passing the coil 460 therethrough and positioned on the magnet 430, and a second portion 422 connected to the first portion 421 and configured to fasten the support structure 450 to the fastening portion 401.

For example, the first portion 421 may be a portion disposed on the magnet 430. The first portion 421 may be a portion which forms a magnetic field of the support structure 450 together with the magnet 430. For example, the first portion 421 may pass through the coil 460 via the hole 421a so that the coil 460 at least partially faces the magnet 430. For example, the magnet 430 may include a first magnet 431, a second magnet 432 spaced apart from the first magnet 431, and a third magnet between the first magnet 431 and the second magnet 432. For example, the first portion 421 may be positioned on the first magnet 431 and the second magnet 432. The hole 421a of the first portion 421 may be positioned on the third magnet 433 such that the coil 460 passing through the hole 421a is at least partially disposed within a gap between the first magnet 431 and the third magnet 433 and a gap between the second magnet 432 and the third magnet 433. The coil 460 may partially surround the third magnet 433. The coil 460 may be partially surrounding the third magnet 433, and thus the coil 460 may be configured to vibrate by the magnetic field formed by the support structure 450.

For example, the second portion 422 may be referred to as a fastening structure 440 for fastening with the fastening portion 401 of the housing 210. For example, the second portion 422 may extend from the first portion 421 to protrude from the speaker assembly 400. For example, the second portion 422 may include a structure for coupling with the first plate 410.

According to an embodiment, the electronic device 200 may include a fastening member (e.g., the fastening member 490 of FIG. 4A) for fastening the speaker assembly 400 to the housing 210. The second portion 422 may include a first fastening hole 441 for fastening the second plate 420 to the fastening portion 401 by passing the fastening member 490 therethrough, such as along the thickness direction of the speaker assembly 400. For example, the fastening member 490 may couple the second portion 422 with the fastening portion 401 of the housing 210, passing through the first fastening hole 441. Through the fastening member 490, the second portion 422 may be fastened to the fastening portion 401 of the housing 210. As the second portion 422 of the second plate 420 is fastened to the housing 210, the support structure 450 may improve the fastening integrity of the speaker assembly 400 to the housing 210.

Referring to FIG. 5C, the first plate 410 may include a first region 411 on which the magnet 430 is disposed, and a second region 412 extending from the first region 411 and configured to fasten the support structure 450 to the fastening portion 401.

For example, the first region 411 may be a region attached to the magnet 430. The first region 411 may be a region supporting the magnet 430. For example, the first region 411 may be a region facing the coil 460 which passes through the hole 421a of the second plate 420. For example, the second region 412 may be referred to as a fastening structure 440 to be fastened with the fastening portion 401 of the housing 210. For example, the second region 412 may protrude from the speaker assembly 400. For example, the second region 412 may include a structure for coupling with the second plate 420.

According to an embodiment, the electronic device 200 may include a fastening member 490 for fastening the speaker assembly 400 to the housing 210. The housing 210 may include a protruding structure (e.g., the protruding structure 405 of FIG. 4A) spaced apart from the fastening portion 401. The second region 412 may be a region including a structure for coupling with the second plate 420. The second region 412 may include a second fastening hole 442 for fastening the first plate 410 to the fastening portion 401 by passing the fastening member 490 therethrough, and a structure (e.g., first coupling recesses 531 and 532 of FIG. 5B) for fastening the first plate 410 to the second plate 420. The first plate 410 may include a third region 413 extending from the first region 411 and spaced apart from the second region 412, the third region 413 including a coupling hole 443 into which the protruding structure 405 is to be inserted. For example, the fastening member 490 may couple the second region 412 with the fastening portion 401 of the housing 210, passing through the second fastening hole 442. Through the fastening member 490, the second region 412 may be fastened to the fastening portion 401 of the housing 210.

For example, the third region 413 may extend in a direction different from the direction in which the second region 412 extends from the first region 411. The coupling hole 443 in the third region 413 may be fastened to the protruding structure 405 of the housing 210, while the second region 412 is fastened to the fastening portion 401 of the housing 210. The third region 413 may be coupled with the protruding structure 405 to fasten the first plate 410 to the housing 210 together with the second region 412. By fastening the second region 412 and the third region 413 to the housing 210, the support structure 450 may improve the fastening integrity of the speaker assembly 400 to the housing 210.

Referring back to FIGS. 5A, 5B, and 5C, the first plate 410 may include a first coupling structure 530 including first coupling grooves 531 and 532 for coupling with the second plate 420.

The second plate 420 may include a second coupling structure 540 including first protrusions 541 and 542 fastened to the first coupling grooves 531 and 532, respectively. For example, the first plate 410 may include a first region 411 to which the magnet 430 is attached, and a second region 412 extending from the first region 411. The second plate 420 may include a first portion 421 positioned on the magnet 430, and a second portion 422 extending from the first portion 421. The first coupling structure 530 may be formed within the second region 412 for coupling to the second coupling structure 540. For example, the second coupling structure 540 may be formed within the second portion 422.

For example, the first protrusions 541 and 542 may be at least partially positioned within the first coupling grooves 531 and 532, respectively, thereby fastening the second plate 420 and the first plate 410. For example, the first protrusions 541 and 542 may have the shapes corresponding to the first coupling grooves 531 and 532, respectively. For example, the first protrusions 541 and 542 may be coupled through soldering with the first coupling grooves 531 and 532. However, the disclosure is not limited thereto.

Although the first coupling structure 530 and the second coupling structure 540 have been described as a structure for coupling the first plate 410 and the second plate 420, the disclosure is not limited thereto. The first plate 410 and the second plate 420 may each include a plurality of coupling structures for coupling with each other. By coupling the first plate 410 and the second plate 420, the support structure 450 may improve the fastening integrity of the speaker assembly 400 to the housing 210 and enhance the sound quality of audio output from the speaker assembly 400.

According to an embodiment, the speaker assembly 400 may include a frame 510 which supports the diaphragm 470 and is coupled on the second plate 420. The second plate 420 may include a third coupling structure 550 including second protrusions 551, 552, 553, and 554 for coupling with the frame 510. The frame 510 may include a fourth coupling structure 560 including second coupling grooves 561, 562, 563, and 564 fastened to the second protrusions 551, 552, 553, and 554, respectively.

For example, the frame 510 may be coupled with the diaphragm 470. The frame 510 may be disposed between the diaphragm 470 and the support structure 450. For example, the frame 510 may be configured to press or apply a force to the diaphragm 470 in a direction toward a support portion (e.g., the support portion 402 of FIG. 4A) of the housing 210, while the speaker assembly 400 is fastened to the fastening portion 401 of the housing 210. For example, the frame 510 may be disposed on the support structure 450. The frame 510 may be in contact with the second plate 420 and/or the magnet 430 of the support structure 450. The frame 510 may be coupled with the support structure 450 to form at least a portion of an appearance of the speaker assembly 400 and support the diaphragm 470.

For example, the second plate 420 may include a first portion 421 positioned on the magnet 430, and a second portion 422 extending from the first portion 421. In an embodiment, the third coupling structure 550 may be formed within the first portion 421 for coupling to the frame 510. The second portion 422 may be a portion for fastening the speaker assembly 400 to the fastening portion 401 of the housing 210. For example, the second protrusions 551, 552, 553, and 554 may be received within the second coupling grooves 561, 562, 563, and 564, respectively, thereby coupling the second plate 420 and the frame 510. For example, the second protrusions 551, 552, 553, and 554 may have shapes corresponding to the shapes of the second coupling grooves 561, 562, 563, and 564. For example, the second protrusions 551, 552, 553, and 554 may be coupled with the second coupling grooves 561, 562, 563, and 564, respectively, through soldering. However, the disclosure is not limited thereto.

Although the third coupling structure 550 and the fourth coupling structure 560 have been described as a structure for coupling the support structure 450 and the frame 510, the disclosure is not limited thereto. The support structure 450 and the frame 510 may each include a plurality of coupling structures for coupling with each other. By coupling the support structure 450 and the frame 510, the speaker assembly 400 may improve the fastening integrity of the speaker assembly 400 to the housing 210 and improve the sound quality of audio output from the speaker assembly 400.

According to the above-described embodiment, the speaker assembly 400 of the electronic device 200 is configured such that the support structure 450 forming a magnetic field is fastened to the housing 210, thereby improving the fastening integrity of the speaker assembly 400 to the housing 210. The support structure 450 may improve the sound quality of audio output from the speaker assembly 400 owing to including a structure of the first plate 410 and the second plate 420 being coupled to each other.

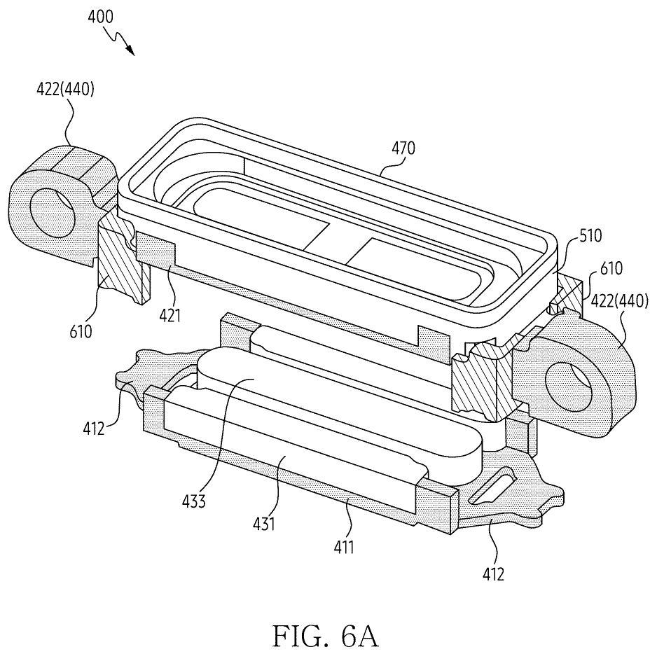

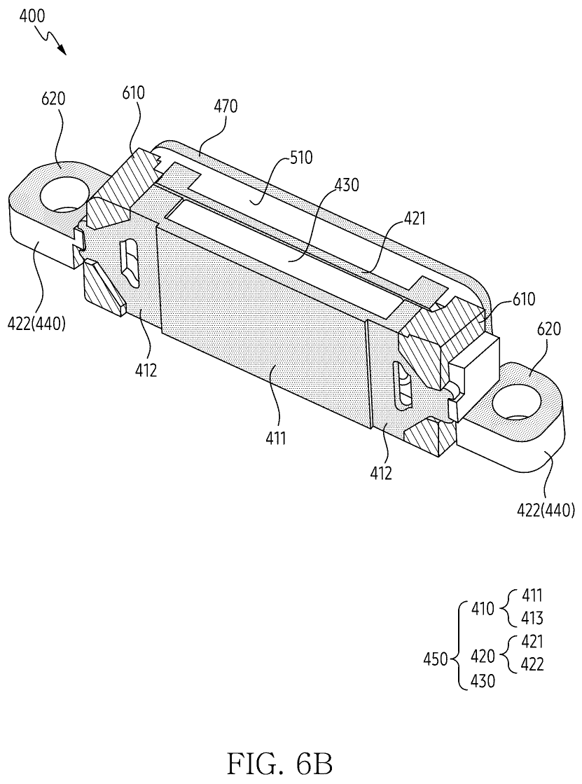

FIG. 6A is a partially exploded perspective view of a speaker assembly 400 of an electronic device 200. FIG. 6B is a perspective view of an assembled a speaker assembly 400 of an example electronic device. FIG. 6B be

Referring to FIGS. 6A and 6B, an electronic device (e.g., the electronic device 200 of FIG. 2A) may include a housing (e.g., the housing 210 of FIG. 2A) including a fastening portion (e.g., the fastening portion 401 of FIG. 4A), and a speaker assembly 400 disposed within the housing 210 and configured to output audio. The speaker assembly 400 may include a support structure 450 forming a magnetic field and including a first plate 410, a magnet 430 attached to the first plate 410, and a second plate 420 coupled with the first plate 410 and disposed at least partially on the magnet 430. The speaker assembly 400 may include a coil (e.g., the coil 460 of FIG. 4B) configured to vibrate by the magnetic field, and a diaphragm 470 attached to the coil 460. The support structure 450 may be fastened to the fastening portion 401 in order to couple the speaker assembly 400 to the housing 210. According to an embodiment, the first plate 410 may include a first coupling structure 530 for coupling with the second plate 420. The second plate 420 may include a second coupling structure 540 coupled with the first coupling structure 530. According to an embodiment, the speaker assembly 400 may include a frame 510 which supports the diaphragm 470 and is coupled onto the second plate 420. The second plate 420 may include a third coupling structure 550 for coupling with the frame 510. The frame 510 may include a fourth coupling structure 560 coupled with the third coupling structure 550.

According to an embodiment, the speaker assembly 400 may include a coupling member 610 which is fastened with the frame 510, the first plate 410, and the second plate 420 to couple the support structure 450 with the frame 510. For example, the coupling member 610 may contact the support structure 450 and the frame 510. For example, the coupling member 610 may couple the frame 510 with the second plate 420. The coupling member 610 may couple the second plate 420 with the first plate 410 to which the magnet 430 is attached. For example, the first plate 410 may include a first region 411 to which the magnet 430 is attached, and a second region 412 extending from the first region 411. The second plate 420 may include a first portion 421 positioned on the magnet 430, and a second portion 422 extending from the first portion 421. The coupling member 610 may fasten the second portion 422 to the second region 412. The coupling member 610 may fasten the second portion 422 to the frame 510. However, the disclosure is not limited thereto. The speaker assembly 400 may include the coupling member 610 for fastening the frame 510, the first plate 410, and the second plate 420, thereby improving a coupling force between components of the speaker assembly 400 and enhancing the sound quality of audio output from the speaker assembly 400.

According to an embodiment, the coupling member 610 may include at least one of plastic or metal material in order to fasten the frame 510, the first plate 410, and/or the second plate 420 to each other, but the disclosure is not limited thereto. By including the coupling member 610, the speaker assembly 400 may reduce separation of each component of the speaker assembly 400 from the speaker assembly 400.

According to an embodiment, the support structure 450 may further include a fastening structure 440 supported by the fastening portion 401 and configured to fasten the speaker assembly 400 to the fastening portion 401. The fastening structure 440 may be formed at least partially by at least one of the first plate 410 or the second plate 420. The support structure 450 may include a (electrical) shielding member 620 attached on the fastening structure 440 in order to electrically disconnect the housing 210 and the speaker assembly 400. For example, the shielding member 620 may include a non-conductive material. The shielding member 620 may be disposed on one surface of the fastening structure 440 facing the fastening portion 401 when the fastening structure 440 is fastened to the fastening portion 401 of the housing 210. For example, the shielding member 620 may be disposed to be interposed between the fastening structure 440 and the fastening portion 401, while the speaker assembly 400 is fastened to the fastening portion 401. The support structure 450 may include the shielding member 620, thereby electrically disconnecting the housing 210 from the first plate 410 and/or the second plate 420 having conductivity. The shielding member 620 may further enhance the sound quality of audio output from the speaker assembly 400 by electrically disconnecting the housing 210 from the first plate 410 and/or the second plate 420.

According to the above-described embodiment, the speaker assembly 400 of the electronic device 200 includes the coupling member 610 for coupling the support structure 450 and the frame 510, thereby improving the coupling force between the components of the speaker assembly 400 and enhancing the sound quality of audio output from the speaker assembly 400. The support structure 450 may further improve the sound quality of audio output from the speaker assembly 400 by including the shielding member 620 attached on the fastening structure 440 for fastening with the housing 210.

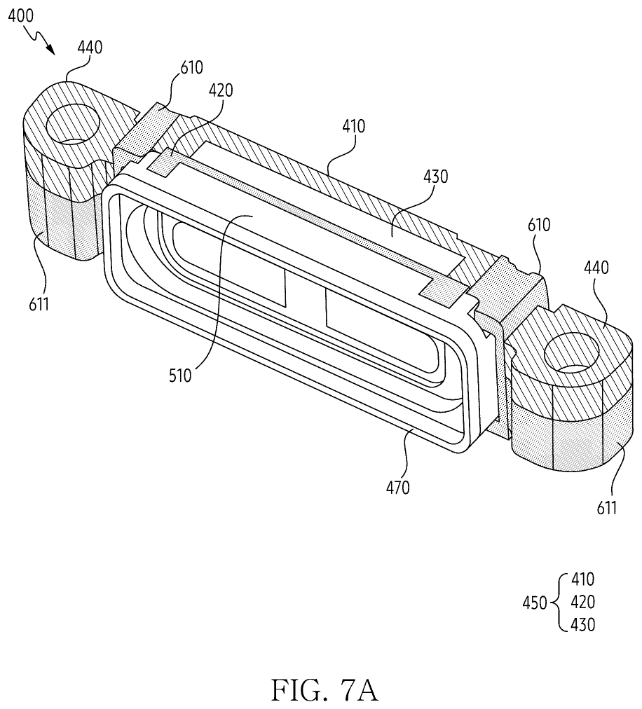

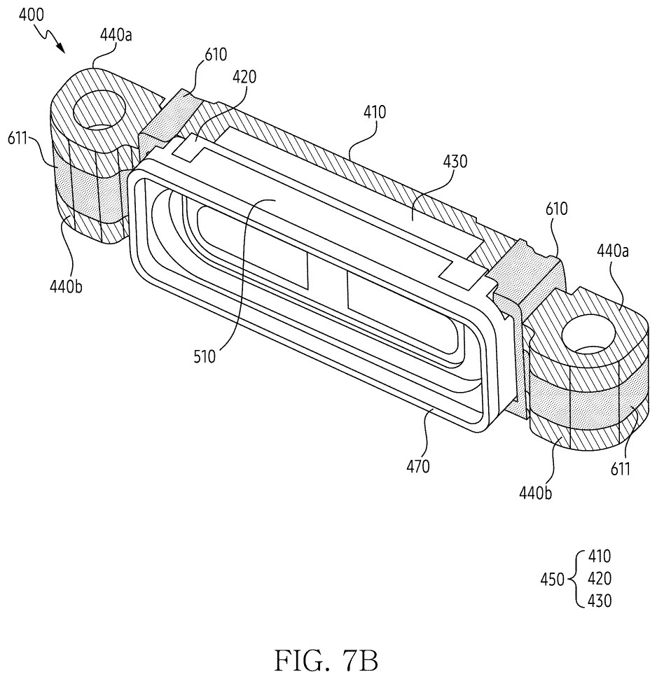

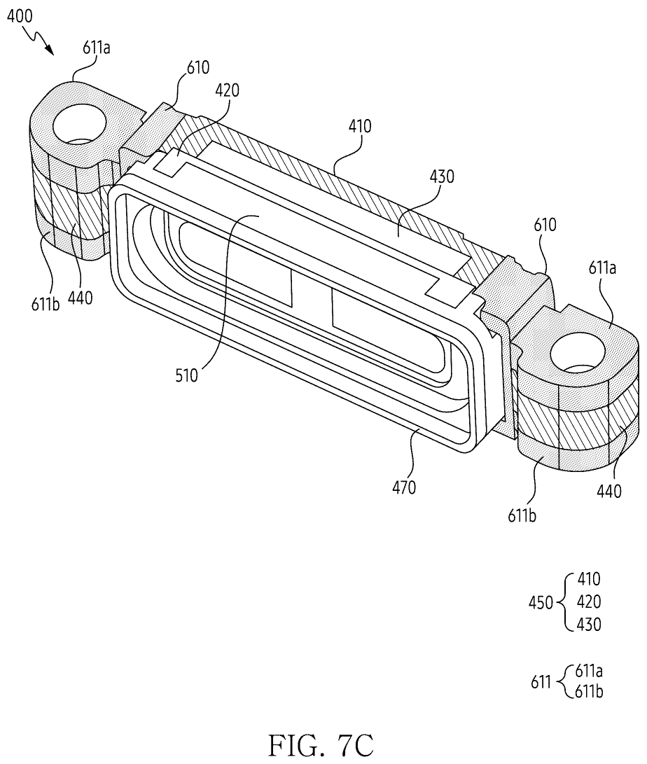

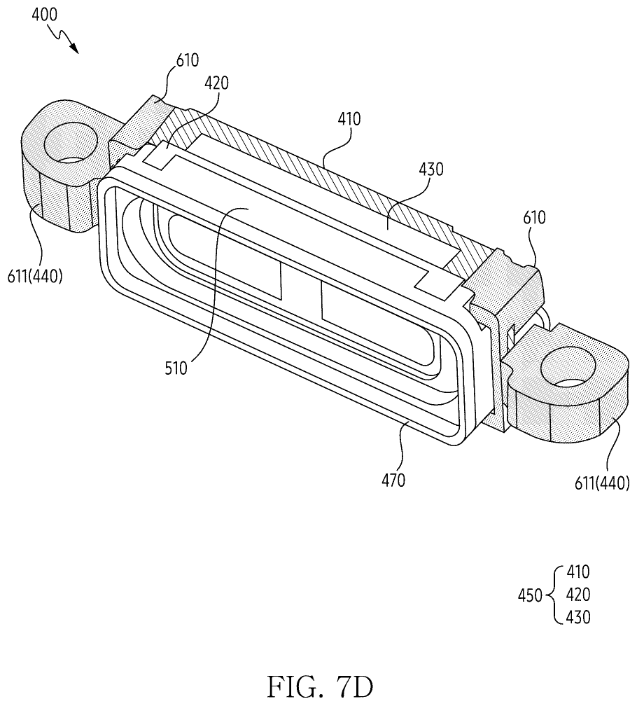

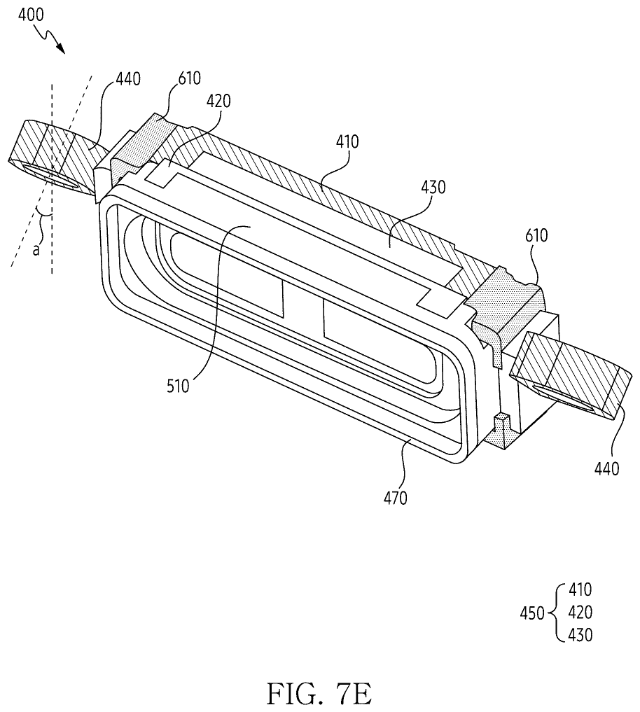

FIGS. 7A, 7B, 7C, 7D, and 7E are perspective views of a speaker assembly 400 of an example electronic device.

Referring to FIGS. 7A, 7B, 7C, 7D, and 7E, the electronic device (e.g., the electronic device 200 of FIG. 2A) may include a housing (e.g., the housing 210 of FIG. 2A) including a fastening portion (e.g., the fastening portion 401 of FIG. 2A), and a speaker assembly 400 disposed within the housing 210 and configured to output audio. The speaker assembly 400 may include a support structure 450 forming a magnetic field and including a first plate 410, a magnet 430 attached to the first plate 410, and a second plate 420 coupled with the first plate 410 and disposed at least partially on the magnet 430. The speaker assembly 400 may include a coil (e.g., the coil 460 of FIG. 4B) configured to vibrate by the magnetic field, and a diaphragm 470 attached to the coil 460. The speaker assembly 400 may include a frame 510 which supports the diaphragm 470 and is coupled on the second plate 420. The support structure 450 may be fastened to the fastening portion 401 in order to couple the speaker assembly 400 to the housing 210. The support structure 450 may include a fastening structure 440 supported by the fastening portion 401 and configured to fasten the speaker assembly 400 to the fastening portion 401. The fastening structure 440 may be formed at least partially by at least one of the first plate 410 or the second plate 420. The speaker assembly 400 may include a coupling member 610 which couples the support structure 450 with the frame 510 by being fastened with the frame 510, the first plate 410, and the second plate 420.

Referring to FIGS. 7A, 7B, and 7C, the coupling member 610 may include an assembling structure 611 for supporting the fastening structure 440. For example, the assembling structure 611 may protrude from the speaker assembly 400 to be coupled with the fastening structure 440. For example, the assembling structure 611 may be in contact with the fastening structure 440. For example, the assembling structure 611 may be fastened to the fastening portion 401 of the housing 210 together with the fastening structure 440.

Referring to FIG. 7B, the fastening structure 440 may include a first fastening region 440a and a second fastening region 440b spaced apart from the first fastening region 440a. The assembling structure 611 of the coupling member 610 may reinforce the fastening structure 440 by being interposed between the first fastening region 440a and the second fastening region 440b.

Referring to FIG. 7C, the assembling structure 611 may include a first assembling portion 611a and a second assembling portion 611b spaced apart from the first assembling portion 611a. The fastening structure 440 may be disposed between the first assembling portion 611a and the second assembling portion 611b. The first assembling portion 611a and the second assembling portion 611b may support the fastening structure 440 to reinforce the fastening structure 440.

Referring to FIG. 7D, a portion of the fastening structure 440 may be formed by the assembling structure 611. In such a case, the remaining portion of the fastening structure 440 may be formed by the first plate 410 and/or the second plate 420 of the support structure 450. The assembling structure 611 may reinforce or replace the fastening structure 440 by forming at least a portion of the fastening structure 440.

Referring to FIGS. 7A to 7D, for example, a fastening direction (e.g., open direction or penetrating direction of the respective holes in the fastening structure 440 may be oriented in a thickness direction of the speaker assembly 400, that is, a direction crossing the stacked direction of the various plates of the speaker assembly 400.

Referring to FIG. 7E, an angle ‘a’ of the fastening structure 440 relative to the speaker assembly 400 may be adjusted. In an embodiment, the fastening structure 440 may form various angles ‘a’ with respect to the speaker assembly 400 to increase the fastening integrity of the speaker assembly 400 to the housing 210. For example a rotation axis may be defined along a length of the speaker assembly 400, that is along a direction in which the fastening structure 440 is disposed at opposite ends of the speaker assembly 400.

According to an embodiment, the fastening structure 440 may be configured to be rotatable relative to the speaker assembly 400. By being rotatable relative to the speaker assembly 400, the fastening structure 440 may have various angles a with respect to the speaker assembly 400. For example, the speaker assembly 400 may include a bearing (not shown) or a wheel structure (not shown) coupled with the fastening structure 440 and configured to rotate the fastening structure 440 with respect to the speaker assembly 400. The structure configured to rotate the fastening structure 440 may be formed, for example, within the coupling member 610. The fastening structure 440 may further improve the fastening integrity of the fastening structure 440 relative to the housing 210 by being configured such that the angle a is adjustable.

According to the above-described embodiment, the speaker assembly 400 of the electronic device 200 may include the assembling structure 611 configured to form at least a portion of the fastening structure 440 fastened with the fastening portion 401 of the housing 210 or support the fastening structure 440, thereby reducing damage to the fastening structure 440 by an external impact and improving the fastening integrity of the fastening structure 440 relative to the housing 210.

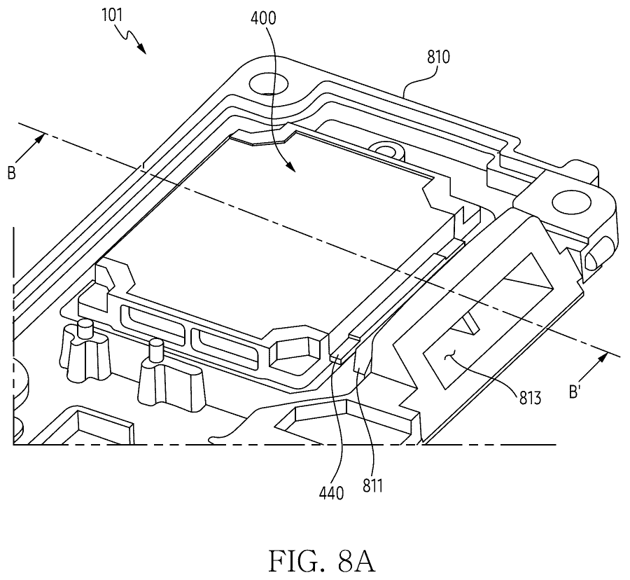

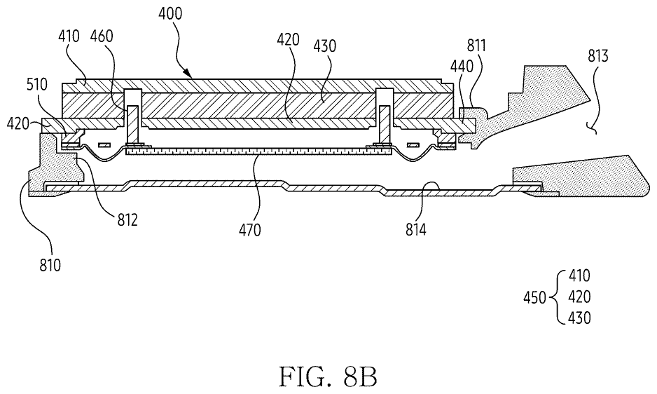

FIG. 8A illustrates a part of an example electronic device 101. FIG. 8B is a partial cross-sectional view of the example electronic device 101 taken along line B-B′ of FIG. 8A.

Referring to FIGS. 8A and 8B, the electronic device 101 may include a housing 810 including a fastening portion 811, and a speaker assembly 400 disposed within the housing 810 and configured to output audio. The speaker assembly 400 may include a support structure 450 forming a magnetic field and including a first plate 410, a magnet 430 attached to the first plate 410, and a second plate 420 coupled with the first plate 410 and disposed at least partially on the magnet 430. The speaker assembly 400 may include a coil 460 configured to vibrate by the magnetic field, and a diaphragm 470 attached to the coil 460. The support structure 450 may be fastened to the fastening portion 811 in order to couple the speaker assembly 400 to the housing 810. According to an embodiment, the housing 810 may include a support portion 812. The support portion 812 may support the diaphragm 470 of the speaker assembly 400. The support portion 812 may support the speaker assembly 400 at the diaphragm 470. According to an embodiment, the housing 810 may include a speaker hole 813 and an acoustic duct 814.

According to an embodiment, the electronic device 101 may be an electronic device distinct from the electronic device 200 illustrated in FIGS. 2A to 7B. For example, the electronic device 101 may be referred to as the electronic device 101 of FIG. 1, which is connectable to the electronic device 200 illustrated in FIGS. 2A to 7B.

According to an embodiment, the support structure 450 may include a fastening structure 440 for being fastened to a fastening portion 811 of the housing 810. The fastening structure 440 may be formed, for example, on (or by) the first plate 410 or the second plate 420 of the support structure 450. As the support structure 450 is fastened to the housing 810, it may further improve the fastening integrity of the speaker assembly 400 relative to the housing 810.

For example, the speaker assembly 400 may be disposed on an acoustic duct 814 connected to a speaker hole 813. The diaphragm 470 of the speaker assembly 400 may be disposed toward the acoustic duct 814 to output sound through the speaker hole 813. By being fastened to the fastening portion 811 of the housing 810, the fastening structure 440 of the speaker assembly 400 may fix the speaker assembly 400 to the housing 810 such that the diaphragm 470 faces the acoustic duct 814. For example, the fastening structure 440 may be configured to protrude from the second plate 420 of the support structure 450 to be coupled with the fastening portion 811 of the housing 810. For example, although not shown herein, the fastening structure 440 may be configured to protrude from the first plate 410 of the support structure 450 to be coupled with the fastening portion 811 of the housing 810. For example, the fastening structure 440 may be coupled with the fastening portion 811 of the housing 810 through a fastening member (e.g., the fastening member 490 of FIG. 4A). For example, the frame 510 coupled with the support structure 450 and configured to support the diaphragm 470 may be seated on the support portion 812 of the housing 810. The speaker assembly 400 may be coupled with the housing 810 such that the fastening structure 440 is fastened to the fastening portion 811 of the housing 810 and the frame 510 is supported on the support portion 812 of the housing 810, thereby improving the fastening integrity to the housing 810. However, the disclosure is not limited thereto.

The speaker assembly 400 may be disposed within various electronic devices including the electronic device 101 and the electronic device 200. The support structure 450 forming a magnetic field of the speaker assembly 400 may be configured to be fastened with housings of the various electronic devices, thereby improving the fastening integrity of the speaker assembly 400 in the various electronic devices.

According to the above-described embodiment, the speaker assembly 400 of the electronic device 101 may include the support structure 450 which is fastened with the fastening portion 811 of the housing 810 of the electronic device 101 and forms a magnetic field, thereby improving the fastening integrity of the speaker assembly 400 relative to the housing 810.

According to the above-described embodiment, an electronic device (e.g., the electronic device 101 of FIG. 1 or the electronic device 200 of FIG. 2A) may include a housing (e.g., the housing 210 of FIG. 2A, the housing 810 of FIG. 8A) including a fastening portion (e.g., the fastening portion 401 of FIG. 2A, the fastening portion 811 of FIG. 8A). The electronic device may include a speaker assembly (e.g., the speaker assembly 400 of FIG. 4A) disposed in the housing and configured to output audio. The speaker assembly may include a support structure (e.g., the support structure 450 of FIG. 4B) forming a magnetic field and including a first plate (e.g., the first plate 410 of FIG. 4B), a magnet (e.g., the magnet 430 of FIG. 4B) attached to the first plate, and a second plate (e.g., the second plate 420 of FIG. 4B) coupled with the first plate and disposed at least partially on the magnet. The speaker assembly may include a coil (e.g., the coil 460 of FIG. 4B) configured to vibrate by the magnetic field, and a diaphragm (e.g., the diaphragm 470 of FIG. 4B) attached to the coil. The support structure may be fastened to the fastening portion to couple the speaker assembly to the housing. According to the aforementioned embodiment, the speaker assembly may be configured such that the support structure forming the magnetic field is fastened to the housing, thereby improving the fastening integrity of the speaker assembly to the housing and enhancing the sound quality of audio output from the speaker assembly. The above-mentioned embodiment may provide various effects including the above-mentioned effects.

According to an embodiment, the second plate may include a first portion (e.g., the first portion 421 of FIG. 5A) including a hole (e.g., the hole 421a of FIG. 5A) for passing the coil therethrough and attached to the magnet, and a second portion (e.g., the second portion 422 of FIG. 5A) connected to the first portion and configured to fasten the support structure to the fastening portion. According to the above-mentioned embodiment, the speaker assembly may be configured such that the second plate is fastened to the housing, thereby improving the fastening integrity of the speaker assembly to the housing and enhancing the sound quality of the audio output from the speaker assembly. For example, the second plate of the speaker assembly may include a first portion at which the second plate overlaps the magnet, the first portion including a hole defined therein through which the coil passes, and a second portion connected to the first portion and at which the support structure is fastened to the fastening portion of the housing.

According to an embodiment, the electronic device may further include a fastening member (e.g., the fastening member 490 of FIG. 4A) for fastening the speaker assembly to the housing. The second portion may include a fastening hole (e.g., the first fastening hole 441 of FIG. 5A) for fastening the second plate to the fastening portion by passing the fastening member therethrough. According to the above-mentioned embodiment, the speaker assembly may be configured such that the second plate is fastened to the housing, thereby improving the fastening integrity of the speaker assembly to the housing and enhancing the sound quality of the audio output from the speaker assembly. The above-mentioned embodiment may provide various effects including the aforementioned effects. For example, the electronic device may further include a fastening hole defined in the second portion of the second plate, and a fastening member which passes through the fastening hole of the second plate and fastens the speaker assembly to the fastening portion of the housing.

According to an embodiment, the first plate may include a first region (e.g., the first region 411 of FIG. 5C) on which the magnet is disposed, and a second region (e.g., the second region 412 of FIG. 5C) extending from the first region and configured to fasten the support structure to the fastening portion. According to the above-mentioned embodiment, the speaker assembly may be configured such that the first plate is fastened to the housing, thereby improving the fastening integrity of the speaker assembly to the housing and enhancing the sound quality of the audio output from the speaker assembly. The above-mentioned embodiment may provide various effects including the aforementioned effects. For example, the first plate of the speaker assembly may include a first region on which the magnet is disposed, and a second region extending from the first region at at which the support structure is fastened to the fastening portion of the housing.

According to an embodiment, the electronic device may further include a fastening member for fastening the speaker assembly to the housing. The housing may further include a protruding structure (e.g., the protruding structure 405 of FIG. 4A) spaced apart from the fastening portion. The first plate may further include a third region (e.g., the third region 414 of FIG. 5C) spaced apart from the second region, the third region extending from the first region and including a coupling hole (e.g., the coupling hole 443 of FIG. 5C) into which the protruding structure is to be inserted. The second region may include a fastening hole (e.g., the second fastening hole 442 of FIG. 5C) for fastening the first plate to the fastening portion by passing the fastening member therethrough. According to the above-mentioned embodiment, the speaker assembly may be configured such that the first plate is fastened to the housing, thereby improving the fastening integrity of the speaker assembly to the housing and enhancing the sound quality of the audio output from the speaker assembly. The above-mentioned embodiment may provide various effects including the aforementioned effects. For example, the electronic device may include a fastening hole defined in the second region of the first plate, and a fastening member which passes through the fastening hole of the first plate and fastens the speaker assembly to the fastening portion of the housing. The housing may further include a protruding structure spaced apart from the fastening portion. The first plate may further include a third region spaced apart from the second region and extending from the first region toward the protruding structure, the third region including a coupling hole defined therein and into which the protruding structure is inserted to fasten the speaker assembly to the protruding structure of the housing.

According to an embodiment, the first plate may include a first coupling structure (e.g., the first coupling structure 530 of FIG. 5B) including first coupling grooves (e.g., the first coupling grooves 531 and 532 of FIG. 5B) for coupling with the second plate. The second plate may include a second coupling structure (e.g., the second coupling structure 540 of FIG. 5B) including first protrusions (e.g., the first protrusions 541 and 542 of FIG. 5B) fastened to the first coupling grooves, respectively. According to the above-mentioned embodiment, the speaker assembly may include the structure in which the first plate is coupled to the second plate, thereby improving the fastening integrity of the speaker assembly to the housing and enhancing the sound quality of the audio output from the speaker assembly. The above-mentioned embodiment may provide various effects including the aforementioned effects. For example, the first plate may include first coupling grooves at which the first plate is coupled to the second plate, and the second plate may include first protrusions which engage with the first coupling grooves to couple the first plate to the second plate.

According to an embodiment, the speaker assembly may further include a frame (e.g., the frame 510 of FIG. 5A) which supports the diaphragm and is coupled on the second plate. The second plate may include a third coupling structure (e.g., the third coupling structure 550 of FIG. 5A) including second protrusions (e.g., the second protrusions 551, 552, 553, and 554 of FIG. 5A) for coupling with the frame. The frame may include a fourth coupling structure (e.g., the fourth coupling structure 560 of FIG. 5A) including second coupling grooves (e.g., the second coupling grooves 561, 562, 563, and 564 of FIG. 5A) fastened to the second protrusions, respectively. According to the above-mentioned embodiment, the speaker assembly may include the structure in which the support structure is coupled to the frame, thereby improving the fastening integrity of the speaker assembly to the housing and further enhancing the sound quality of the audio output from the speaker assembly. The above-mentioned embodiment may provide various effects including the aforementioned effects. For example, the speaker assembly may further include a frame supporting the diaphragm, the frame coupled to the second plate, the frame may include second coupling grooves at which the frame is coupled to the second plate, and the second plate may include second protrusions which engage with the second coupling grooves to couple the second plate to the frame.

According to an embodiment, the speaker assembly may further include a coupling member (e.g., the coupling member 610 of FIG. 6A) fastened to the frame, the first plate, and the second plate, thereby coupling the support structure with the frame. According to the above-mentioned embodiment, the speaker assembly may include the coupling member, thereby improving the fastening integrity of the speaker assembly to the housing and enhancing the sound quality of the audio output from the speaker assembly. The above-mentioned embodiment may provide various effects including the aforementioned effects. For example, the speaker assembly may further include a coupling member which is fastened to each of the frame, the first plate and second plate and couples the support structure to the frame.

According to an embodiment, the housing may further include a support portion (e.g., the support portion 402 of FIG. 4B) for supporting the speaker assembly. The diaphragm may include a first elastic member (e.g., the first elastic member 471 of FIG. 4B) attached to the coil, and a second elastic member (e.g., the second elastic member 472 of FIG. 4B) extending from the first elastic member and configured to reduce inflow of foreign substances from the outside of the electronic device to the magnet by being at least partially pressed (or held taut) by the support portion. According to the mentioned embodiment, by including the first elastic member and the second elastic member, the diaphragm may provide sound to a user and reduce the foreign substances introduced into the electronic device from the outside. The aforementioned embodiment may provide various effects including those described above. For example, the housing may further include a supporting portion which is in the housing, spaced apart from the fastening portion and supports the speaker assembly in the housing,. The diaphragm may include a first elastic member at which the diaphragm is attached on the coil, the first elastic member configured to output the audio signal by vibration of the coil, and a second elastic member which extends from the first elastic member and is attached to the supporting portion of the housing to resist a force from inflow of foreign substances into the magnet from an outside of housing.

According to an embodiment, the magnet may include a first magnet (e.g., the first magnet 431 of FIG. 4B) attached to the second plate, a second magnet (e.g., the second magnet 432 of FIG. 4B) attached to the second plate and spaced apart from the first magnet along the second plate, and a third magnet (e.g., the third magnet 433 of FIG. 4B) between the first magnet and the second magnet, along the second plate. The coil may be configured to partially surround the third magnet. According to the mentioned embodiment, by partially surrounding the third magnet, the coil may be configured to vibrate under the magnetic field generated by the coil. The aforementioned embodiment may provide various effects including those described above.

According to an embodiment, the support structure may further include a fastening structure (e.g., the fastening structure 440 of FIG. 4A) supported by the fastening portion and configured to fasten the speaker assembly to the fastening portion. The fastening structure may be formed at least partially by at least one of the first plate or the second plate. According to the above-mentioned embodiment, the speaker assembly may be configured such that the support structure, which forms the magnetic field, is fastened to the housing, thereby improving the fastening integrity of the speaker assembly to the housing and enhancing the sound quality of audio output from the speaker assembly. The aforementioned embodiment may provide various effects including those described above. For example, the support structure may further include a fastening structure at which the support structure is fastened to the fastening portion of the housing. The fastening structure may be defined by the first plate or the second plate.

According to an embodiment, the support structure may further include a shielding member (e.g., the shielding member 620 of FIG. 6B) attached on the fastening structure to electrically disconnect the housing and the speaker assembly. According to the aforementioned embodiment, by including the electrical shielding member, the support structure may enhance the sound quality of the audio output from the speaker assembly. The aforementioned embodiment may provide various effects including those described above.

According to an embodiment, the housing may further include a speaker hole (e.g., the speaker hole 208 of FIG. 4A or the speaker hole 813 of FIG. 8A), and an acoustic duct (e.g., the acoustic duct 403 of FIG. 4B or the acoustic duct 814 of FIG. 8B) for the audio, extending from the speaker hole to the diaphragm of the speaker assembly fastened to the fastening portion. According to the aforementioned embodiment, the housing may include the speaker hole and the acoustic duct, thereby providing a path for the audio output from the speaker assembly. The aforementioned embodiment may provide various effects including those described above. For example, the housing may further include a speaker hole defined therein, and an acoustic duct which extends from the speaker hole to the diaphragm of the speaker assembly and through which the audio signal is output from the speaker assembly to outside the electronic device.

According to an embodiment, the electronic device may further include a support member (e.g., the support member 480 of FIG. 4A) fastened to the fastening portion and supporting the first plate of the speaker assembly fastened to the fastening portion. According to the aforementioned embodiment, by including the support member, the electronic device may prevent detachment of the speaker assembly from the housing. The aforementioned embodiment may provide various effects including those described above. For example, the electronic device may include a supporting member which is fastened to the housing at the fastening portion, the supporting member extending along the first plate of the speaker assembly fastened to the housing at the fastening portion.

According to an embodiment, the first plate and the second plate may each include metal. According to the above-mentioned embodiment, the first plate and the second plate may each include metal to form a magnetic field together with the magnet and improve the fastening integrity of the speaker assembly relative to the housing. The aforementioned embodiment may provide various effects including those described above.

According to an embodiment, an electronic device may include a housing including a fastening portion. The electronic device may include a speaker assembly disposed within the housing and configured to output audio. The speaker assembly may include a support structure forming a magnetic field and including a first plate, a magnet attached to the first plate, a second plate coupled with the first plate and disposed at least partially on the magnet, and a fastening structure supported by the fastening portion and configured to fasten the speaker assembly to the fastening portion. The speaker assembly may include a diaphragm configured to vibrate by the magnetic field. The fastening structure may be formed at least partially by at least one of the first plate or the second plate. According to the aforementioned embodiment, the speaker assembly may be configured such that the support structure forming the magnetic field is fastened to the housing, thereby improving the fastening integrity of the speaker assembly to the housing and enhancing the sound quality of the audio output from the speaker assembly. The aforementioned embodiment may provide various effects including those described above.

For example, an electronic device includes a housing including a fastening portion in the housing, and a speaker assembly disposed in the housing and configured to output an audio signal, where the speaker assembly includes a support structure fastened to the fastening portion of the housing, the support structure forming a magnetic field and including a first plate, a magnet attached on the first plate, a second plate coupled with the first plate and overlapping the magnet, and a fastening structure at which the speaker assembly is fastened to the fastening portion of the housing, the fastening structure defined by the first plate or the second plate, and a diaphragm configured to vibrate by the magnetic field.

According to an embodiment, the first plate may include a first coupling structure including first coupling grooves for coupling with the second plate. The second plate may include a second coupling structure including first protrusions fastened to the first coupling grooves, respectively. According to the aforementioned embodiment, the speaker assembly may include the structure in which the first plate is coupled with the second plate, thereby improving the fastening integrity of the speaker assembly to the housing and enhancing the sound quality of the audio output from the speaker assembly. The above-mentioned embodiment may provide various effects including those described above.

According to an embodiment, the speaker assembly may further include a frame which supports the diaphragm and is coupled onto the second plate. The second plate may include a third coupling structure including second protrusions for coupling with the frame. The frame may include a fourth coupling structure including second coupling grooves fastened to the second protrusions, respectively. According to the above-mentioned embodiment, the speaker assembly may include the structure in which the support structure is coupled with the frame, thereby improving the fastening integrity of the speaker assembly to the housing and enhancing the sound quality of the audio output from the speaker assembly. The above-mentioned embodiment may provide various effects including those described above.

According to an embodiment, the electronic device may further include a coil attached to the diaphragm and configured to vibrate the diaphragm through interaction with the magnetic field. The housing may further include a support portion for supporting the speaker assembly. The diaphragm may include a first elastic member attached to the coil, and a second elastic member extending from the first elastic member and configured to reduce inflow of foreign substances from the outside of the electronic device to the magnet by being at least partially pressed or held taut by connection to the support portion. According to the above-mentioned embodiment, by including the first elastic member and the second elastic member, the diaphragm may provide sound to a user and reduce the foreign substances introduced into the electronic device from the outside. The above-mentioned embodiment may provide various effects including those described above. For example, the electronic device may further include a coil attached to the diaphragm and configured to vibrate the diaphragm by the magnetic field. The housing may further include a supporting portion which is in the housing, spaced apart from the fastening portion and supports the speaker assembly. The diaphragm may include a first elastic member at which the diaphragm is attached on the coil, the first elastic member configured to output the audio signal by vibration of the coil, and a second elastic member which extends from the first elastic member and is attached to the supporting portion of the housing to resist a force from inflow of foreign substances into the magnet from an outside of housing.

According to an embodiment, the support structure may further include a shielding member attached on the fastening structure in order to electrically disconnect the housing and the speaker assembly. According to the aforementioned embodiment, by including the shielding member, the support structure may enhance the sound quality of the audio output from the speaker assembly. The aforementioned embodiment may provide various effects including those described above.

The electronic device according to various embodiments disclosed herein may be one of various types of electronic devices. The electronic devices may include, for example, a portable communication device (e.g., a smartphone), a computer device, a portable multimedia device, a portable medical device, a camera, a wearable device, or a home appliance. In an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements.

It is to be understood that a singular form of a noun corresponding to an item may include one or more of the things, unless the relevant context clearly indicates otherwise. As used herein, each of such phrases as “A or B,” “at least one of A and B,” “at least one of A or B”, “A, B, or C”, “at least one of A, B, and C”, and “at least one of A, B, or C” may include any one of, or all possible combinations of the items enumerated together in a corresponding one of the phrases. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

As used herein, such terms as “1st” and “2nd”, or “first” and “second” may be used to simply distinguish a corresponding component from another, and does not limit the components in other aspect (e.g., importance or order). In case where an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present. As used herein, elements which are in contact with each other may form an interface therebetween.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

As being overlapping, elements may be disposed along a same line in a direction, such as along a thickness direction, a lateral direction, etc. For example, one element may be above or below another element along a thickness direction, so as to be be considered overlapping each other, without being limited thereto.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used in connection with various embodiments of the disclosure, the term “module” may include a unit implemented in hardware, software, or firmware, and may be interchangeably used with other terms, for example, ‘logic’, ‘logic block’, ‘part’, ‘portion’, or ‘circuit’. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions which are stored in a storage medium (e.g., an internal memory 136 or an external memory 138) which is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Where, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

[166] No claim element is to be construed under the provisions of 35 U.S.C. § 112, sixth paragraph, unless the element is expressly recited using the phrase “means for“ or ”means.”

What is claimed is:

1. An electronic device comprising:
a housing including a fastening portion; and
a speaker assembly disposed in the housing and configured to output an audio signal;
and,
wherein the speaker assembly includes:
a support structure forming a magnetic field and including:
a first plate, a magnet attached on the first plate, and
a second plate coupled with the first plate and at least partially disposed on the magnet;
a coil configured to vibrate by the magnetic field; and
a diaphragm attached to the coil; and,
wherein the support structure is fastened to the fastening portion for coupling the speaker assembly to the housing.

2. The electronic device of claim 1,
wherein the second plate includes:
a first portion defining a hole for passing the coil therethrough, and attached on the magnet; and
a second portion connected to the first portion and for fastening the support structure to the fastening portion.

3. The electronic device of claim 2, further comprising:
a fastening member for fastening the speaker assembly to the housing, and
wherein the second portion defines a fastening hole for fastening the second plate to the fastening portion by passing the fastening member therethrough.

4. The electronic device of claim 1,
wherein the first plate includes:
a first region on which the magnet is disposed; and
a second region extending from the first region and for fastening the support structure to the fastening portion.

5. The electronic device of claim 4, further comprising:
a fastening member for fastening the speaker assembly to the housing, and
wherein the housing further includes a protruding structure spaced apart from the fastening portion, and
wherein the first plate further includes a third region spaced apart from the second region, extending from the first region, and defining a coupling hole into which the protruding structure is inserted, and
wherein the second region defines a fastening hole for fastening the first plate to the fastening portion by passing the fastening member therethrough.

6. The electronic device of claim 1,
wherein the first plate includes a first coupling structure defining first coupling grooves for being coupled with the second plate, and
wherein the second plate includes a second coupling structure including first protrusions respectively fastened to the first coupling grooves.

7. The electronic device of claim 1,
wherein the speaker assembly further includes a frame supporting the diaphragm, and coupled on the second plate, and
wherein the second plate includes a third coupling structure including second protrusions for being coupled to the frame, and
wherein the frame includes a fourth coupling structure defining second coupling grooves respectively fastened to the second protrusions.

8. The electronic device of claim 7,
wherein the speaker assembly further includes a coupling member coupling the support structure to the frame by being fastened to the frame, the first plate, and the second plate.

9. The electronic device of claim 1,
wherein the housing further includes a supporting portion for supporting the speaker assembly, and
wherein the diaphragm includes:
a first elastic member attached on the coil; and
a second elastic member extending from the first elastic member, and for reducing inflow of foreign substances into the magnet from an outside of the electronic device by at least partially being pressurized by the supporting portion.

10. The electronic device of claim 1,
wherein the magnet includes:
a first magnet attached to the second plate;
a second magnet attached to the second plate and spaced apart from the first magnet; and
a third magnet between the first magnet and the second magnet; and, wherein the coil partially surrounds the third magnet.

11. The electronic device of claim 1,
wherein the support structure further includes a fastening structure supported by the fastening portion, and for fastening the speaker assembly to the fastening portion, and
wherein the fastening structure is at least partially formed by at least one of the first plate and the second plate.

12. The electronic device of claim 11,
wherein the support structure further includes a shielding member attached to the fastening structure for electrically disconnecting the housing and the speaker assembly.

13. The electronic device of claim 1,
wherein the housing further includes:
a speaker hole; and
an acoustic duct for the audio signal, the acoustic duct extending from the speaker hole to the diaphragm of the speaker assembly fastened to the fastening portion.

14. The electronic device of claim 1, further comprising:
a supporting member supporting the first plate of the speaker assembly fastened to the fastening portion, and fastened to the fastening portion.

15. The electronic device of claim 1,
wherein the first plate and the second plate each include metal.

16. An electronic device comprising:
a housing including a fastening portion; and
a speaker assembly disposed in the housing and configured to output an audio signal; and,
wherein the speaker assembly includes:
a support structure forming a magnetic field and including:
a first plate, a magnet attached on the first plate,
a second plate at least partially disposed on the magnet, and
a fastening structure supported by the fastening portion, and for fastening the speaker assembly to the fastening portion; and
a diaphragm configured to vibrate by the magnetic field; and,
wherein the fastening structure is at least partially formed by at least one of the first plate, and the second plate.

17. The electronic device of claim 16,
wherein the first plate includes a first coupling structure defining first coupling grooves for being coupled with the second plate, and
wherein the second plate includes a second coupling structure including first protrusions respectively fastened to the first coupling grooves.

18. The electronic device of claim 16,
wherein the speaker assembly further includes a frame supporting the diaphragm, and coupled on the second plate, and
wherein the second plate includes a third coupling structure including second protrusions for being coupled to the frame, and
wherein the frame includes a fourth coupling structure defining second coupling grooves respectively fastened to the second protrusions.

19. The electronic device of claim 16, further comprising:
a coil attached to the diaphragm and configured to vibrate the diaphragm by interacting with the magnetic field; and,
wherein the housing further includes a supporting portion for supporting the speaker assembly, and
wherein the diaphragm includes:
a first elastic member attached on the coil; and
a second elastic member extending from the first elastic member, and for reducing inflow of foreign substances into the magnet from an outside of the electronic device by at least partially being pressurized by the supporting portion.

20. The electronic device of claim 16,
wherein the support structure further includes a shielding member attached to the fastening structure for electrically disconnecting the housing and the speaker assembly.
